(19) United States
(12) Patent Application Publication
(10) Pub. No.: US 2014/0056238 A1
(43) Pub. Date: Feb. 27, 2014

(54) METHOD AND BASE STATION FOR CONTROLLING TRANSMISSION OF DATA STREAMS TO USER EQUIPMENTS IN A WIRELESS COMMUNICATION SYSTEM

(71) Applicant: TELEFONAKTIEBOLAGET L M ERICSSON (publ), Stockholm (SE)

(72) Inventors: Sairamesh Nammi, Stockholm (SE); Anders Jonsson, Taby (SE); Namir Lidian, Solna (SE); Fredrik Ovesjö, Alvsjo (SE)

(73) Assignee: TELEFONAKTIEBOLAGET L M ERICSSON (publ), Stockholm (SE)

(21) Appl. No.: 13/825,088

(22) PCT Filed: Feb. 13, 2013
(86) PCT No.: PCT/SE2013/050122

§ 371 Date: Mar. 19, 2013

Related U.S. Application Data
(60) Provisional application No. 61/611,934, filed on Mar. 16, 2012.

(51) Int. Cl. H04W 72/04; H04L 5/00

(52) U.S. Cl. CPC H04W 72/042; H04L 5/0053
USPC 370/329

(57) ABSTRACT

Disclosed is a base station (130) configured to control transmission of data streams from the base station to a user equipment, UE, in a wireless communication system. The base station (130) provides transmission of at least three data streams. The base station further provides only two different hybrid automatic retransmission request, HARQ, downlink processes (703ab, 704ab). The base station comprises a mapping unit (702) for mapping Medium Access Control enhanced high speed, MAC-ehs, service data units, SDUs belonging to two different data streams of the at least three data streams to the same of the two different HARQ downlink processes. The MAC-ehs SDUs belonging to two different data streams are of equal size. Disclosed is also a corresponding method performed by a base station (130).

### TECHNICAL FIELD

The present disclosure relates generally to a method performed by a base station, a base station and a computer program for controlling transmission of data streams from the base station to a user equipment in a wireless communication system.

### BACKGROUND

In a typical cellular radio system 100, as shown in FIG. 1, wireless terminals 110, also known as mobile stations and/or user equipment units, UEs, communicate via a radio access network, RAN, to one or more core networks 150. The radio access network, RAN, covers a geographical area which is divided into cell 120 areas, with each cell 120 area being served by a base station 130, e.g., a radio base station, RBS, which in some networks may also be called, for example, a “NodeB” in e.g. a Universal Mobile Telecommunications System, UMTS, or “eNodeB” in e.g. a Long Term Evolution, LTE, based system. A cell 120 is a geographical area where radio coverage is provided by the radio base station equipment at a base station 130 site. Each cell 120 is identified by an identity within the local radio area, which is broadcast in the cell. The base stations 130 communicate over the air interface operating on radio frequencies with the user equipment units 110 within range of the base stations.

In some versions of the radio access network, several base stations are typically connected, e.g., by landlines or microwave, to a controller node 140, such as a radio network controller, RNC, or a base station controller, BSC, which supervises and coordinates various activities of the plural base stations connected thereto. The controller nodes 140 are typically connected to one or more core networks 150.

The UMTS is a third generation mobile communication system, which evolved from the second generation Global System for Mobile Communications, GSM. UMTS Terrestrial Radio Access Network, UTRAN, is essentially a radio access network using wideband code division multiple access, WCDMA, for UEs. In a forum known as the Third Generation Partnership Project,3GPP, telecommunications suppliers propose and agree upon standards for third generation networks and UTRAN specifically, and investigate enhanced data rate and radio capacity. Specifications for the Evolved UTRAN, E-UTRAN, are ongoing within the 3GPP.

The E-UTRAN comprises the LTE and System Architecture Evolution, SAE. LTE is a variant of a 3GPP radio access technology wherein the radio base station nodes are connected to a core network, via Access Gateways, AGWs, rather than to RNC nodes. In general, in LTE the functions of a RNC node are distributed between the radio base stations nodes, eNodeB's in LTE, and AGWs. As such, the radio access network of an LTE system has an essentially “flat” architecture comprising radio base station nodes without reporting to RNC nodes.

One result of the work in 3GPP is the High Speed Downlink Packet Access, HSDPA, for the downlink, which was introduced in 3GPP WCDMA specification Release 5. Base stations provided with high-speed downlink packet access capability typically have a high-speed downlink packet access controller, e.g., a HSDPA scheduler or similar channel manager that governs allocation and utilization of a high-speed downlink shared channel, HS-DSCH, and a high-speed shared control channel, HS-SCCH, which is utilized for signaling purposes. The HSDPA controller is commonly referred to also as HSDPA scheduler. The HS-SCCH contains information which is sent to the mobile terminals so that the mobile terminals know if they have data to receive on the HS-DSCH channel or not. The HS-DSCH and the HS-SCCH are separate channels. As understood by those skilled in the art, the signaling carried by the HS-SCCH is performed by transmitting the HS-SCCH Transmission Time Interval, TTI, two slots in advance of the corresponding HS-DSCH TTI. User information is multiplexed for transmission over the entire HS-DSCH bandwidth in time-multiplexed intervals, i.e. TTIs). Since HSDPA uses code multiplexing, several users can be scheduled at the same time.

3GPP WCDMA specification Release 5 provided a medium access control high speed entity, MAC-hs entity. 3GPP UMTS specification Release 7 introduced a new MAC entity, i.e., the MAC-ehs entity, which supports flexible Radio Link Control Packet Data Unit, RLC PDU, sizes and the segmentation of RLC PDUs. In addition, the MAC multiplexing capabilities in Release 7 are improved so that RLC PDUs that carry signaling or data from different radio access bearers can now be multiplexed into a single MAC-ehs PDU. Thus, Release 7 supports features like Multiple Input Multiple Output, MIMO, 64 Quadrature Amplitude Modulation, QAM, and so on. The MAC-ehs entity in the downlink also supports transmitting multiple, maximum of 2, MAC-ehs PDUs in a TTI. This is to support transmission of multiple streams in MIMO and Dual Carrier HSPA.

The HSDPA was followed by introduction of High Speed Uplink Packet Access, HSUPA, with its Enhanced Dedicated Channel, E-DCH, in the uplink in 3GPP WCDMA specification Release 6. E-DCH is a dedicated uplink channel (i.e. transmission from a UE to a Node-B) that has been enhanced for IP transmission. Enhancements include using a short TTI; fast hybrid automatic retransmission request, HARQ, between mobile terminal and the Node-B, with soft combining; scheduling of the transmission rates of mobile terminals from the Node-B. In addition, E-DCH retains majority of the features characteristic for dedicated channels in the uplink.

Currently a 4 transmitter, 4Tx, transmission scheme for HSDPA is discussed within 3GPP standardization. Examples of a 4Tx transmission scheme include a four branch, e.g., four antenna, transmission system. To reduce the signaling in uplink and downlink, it was discussed in 3GPP that it would be advantageous to use two codewords and consequently two fast HARQ processes for a 4 Tx system, see, e.g., 3GPP TS 25.321, Medium Access Control Version 11.0.0. section 4.2.4.6. This would be advantageous because the performance of four branch MIMO with two codeword/HARQ processes is almost equal to that of four codeword/HARQ processes, while being easier to implement and define in 3GPP standard.

### SUMMARY

It is an object of the invention to address at least some of the problems and issues outlined above. Another object is to provide a mechanism to make it possible to use only two HARQ processes for transmitting at least three data streams in a base station for downlink communication to UEs. It is possible to achieve these objects and others by using a method and an apparatus as defined in the attached independent claims.

According to one aspect, a method is provided performed by a base station for controlling transmission of data streams from the base station to a user equipment in a wireless communication system. The base station provides transmission of at least three data streams. The base station further provides only two different hybrid automatic retransmission request, HARQ, downlink processes. The method comprises mapping Medium Access Control enhanced high speed, MAC-ehs, service data units, SDUs belonging to two different data streams of the at least three data streams to the same of the two different HARQ downlink processes. Further, the MAC-ehs SDUs belonging to two different data streams are of equal size. By mapping MAC-ehs SDUs belonging to two different data streams to the same HARQ process in such a way that MAC-ehs SDUs that are of equal size are mapped to the same HARQ process, it is possible to use only two HARQ processes for three or more data streams. In other words, two different data streams may use the same HARQ process. Thereby, a more cost-effective implementation is achieved. Also, transmission performance of the base station is kept on a similar level as if one HARQ process per data stream would have been used.

The term SDU may be interpreted as any type of transport block, such as a packet data unit, PDU, or an SDU.

According to another aspect, a base station is provided, configured to control transmission of data streams from the base station to a user equipment, UE, in a wireless communication system. The base station provides transmission of at least three data streams. The base station further provides only two different hybrid automatic retransmission request, HARQ, downlink processes. The base station comprises a mapping unit for mapping Medium Access Control enhanced high speed, MAC-ehs, service data units, SDUs belonging to two different data streams of the at least three data streams to the same of the two different HARQ downlink processes. The MAC-ehs SDUs belonging to two different data streams are of equal size.

According to yet another aspect, a computer program is provided, comprising computer readable code means arranged to run in a base station configured to control transmission of data streams from the base station to a user equipment, UE. The base station provides transmission of at least three data streams and further provides only two different hybrid automatic retransmission request, HARQ, downlink processes. The code means, when run in such a base station, causes the base station to perform the following step: mapping Medium Access Control enhanced high speed, MAC-ehs, service data units, SDUs belonging to two different data streams of the at least three data streams to the same of the two different HARQ downlink processes. The MAC-ehs SDUs belonging to two different data streams are of equal size.

The above method and apparatus may be configured and implemented according to different optional embodiments. In one possible embodiment, a redundancy version coding for the MAC-ehs SDUs belonging to the two different data streams mapped to the same HARQ downlink process is determined such that the same redundancy version coding is used for the MAC-ehs SDUs belonging to the two different data streams.

Further possible features and benefits of this solution will become apparent from the detailed description below.

### BRIEF DESCRIPTION OF DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic block diagram of a communication system in which embodiments of the present invention may be used.

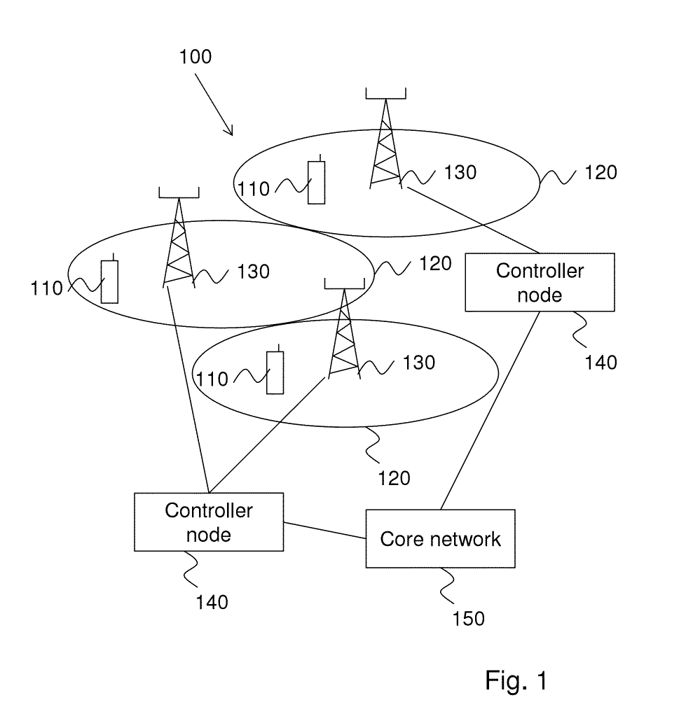

FIG. 2 is a diagrammatic view showing UTRAN side MAC architecture/MAC-ehs details.

FIG. 3 is a diagrammatic view showing an example mapping of the two equal in size MAC-ehs SDUs to one HARQ processes in MAC-ehs UTRAN side.

FIG. 4 is a schematic view of certain example structural aspects of a base station node and a wireless terminal according to an example embodiment.

FIG. 5 is a diagrammatic view depicting example acts or steps performed in an example implementation of the technology disclosed herein.

FIG. 6 is a flow chart describing a method according to an embodiment.

FIG. 7 is a schematic block diagram of a base station according to an embodiment.

FIG. 8 is a schematic block diagram illustrating an arrangement of a base station according to a possible embodiment.

### DETAILED DESCRIPTION

In one of its aspects the technology disclosed herein concerns method and apparatus to implement MAC-ehs entity functionality at the UTRAN side for three streams and four streams transmission in a four branch MIMO system with two HARQ processes.

For being able to use two code words/HARQ processes in MAC-ehs for at least three streams transmission, a proper mechanism is needed to map the MAC-ehs service data units, SDUs, to HARQ processes. Further, in an embodiment, MAC-ehs need to handle the ACK/NACK information and the redundancy version for each HARQ process.

In the following description, for purposes of explanation and not limitation, specific details are set forth, such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor, DSP, hardware, reduced instruction set processor, hardware, e.g., digital or analog circuitry including but not limited to application specific integrated circuit(s), ASIC, and, where appropriate, state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

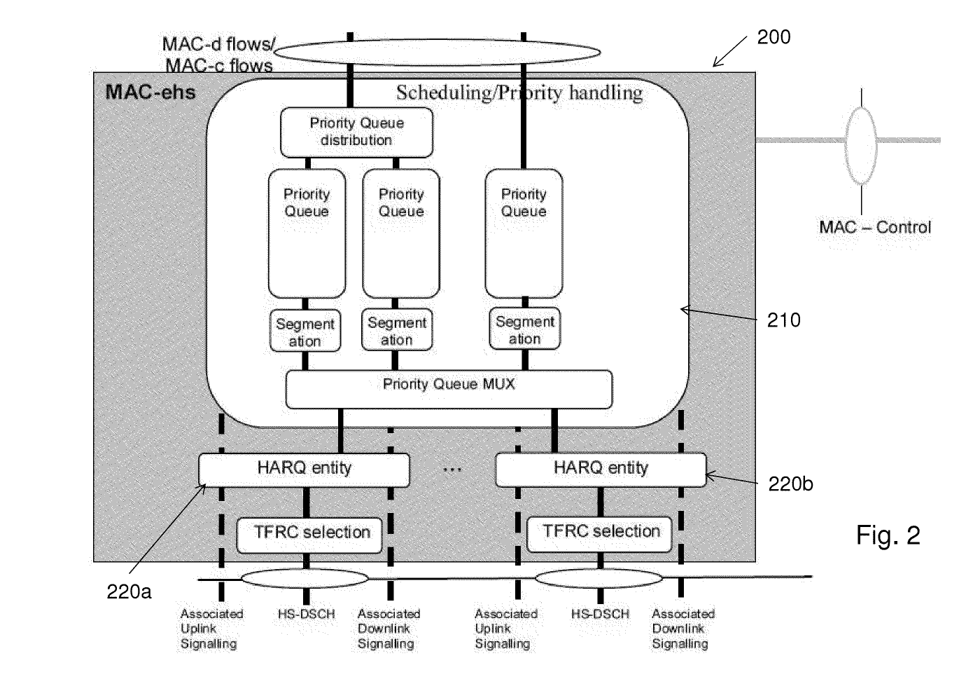

According to 3GPP specification (see, e.g., 3GPP TS 25.321, Medium Access Control Version 11.0.0) there is one HARQ entity per HS-DSCH; one HARQ process per HS-DSCH per TTI for single stream transmission; and two HARQ processes per HS-DSCH per TTI for dual stream. FIG. 2 shows UTRAN side MAC architecture as described in 3GPP TS 25.321, Version 11.0.0, Chapter 4.2.4.6. FIG. 2 further shows a MAC-ehs entity 200 in which the present invention may be used. The MAC-ehs entity 200 comprises a scheduling/priority handling unit 210 and a first and a second HARQ entity 220a, 220b. The first HARQ entity 220a may be used for uplink communication and the second HARQ entity 220b may be used for downlink communication, or vice versa.

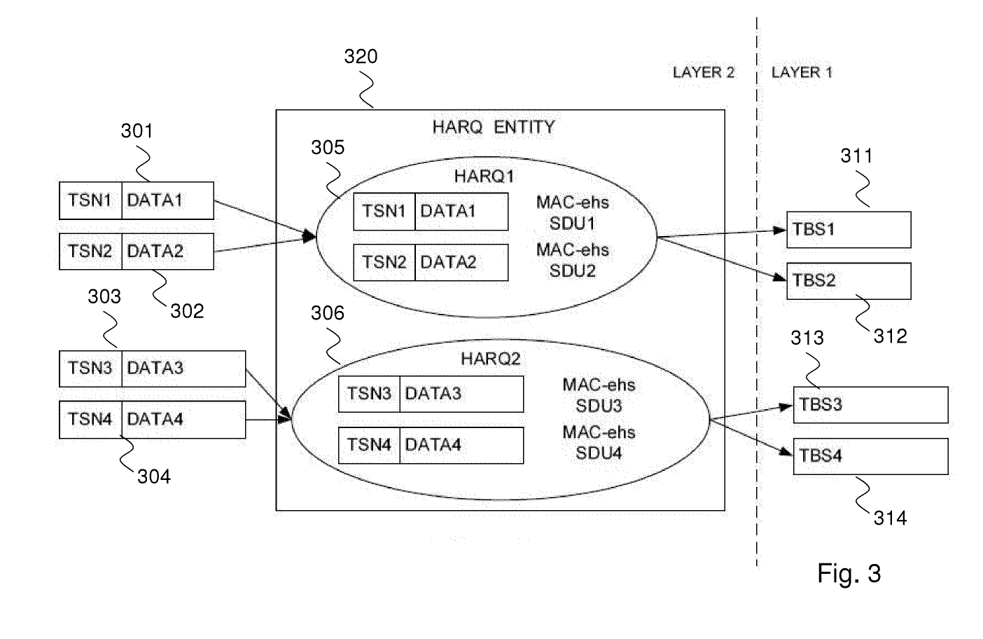

With the introduction of 4Tx transmissions it may be a request that there are only two HARQ processes per HS-DSCH per TTI for three streams and four streams transmissions. This may be solved by the two MAC-ehs SDUs belonging to different streams being logically mapped to one HARQ process as shown in FIG. 3. The two MAC-ehs SDUs that are mapped to one HARQ process may be equal in size.

In FIG. 3 a first MAC-ehs SDU 301 and a second MAC-ehs SDU 302 are input to a HARQ entity 320, such as any of the HARQ entities 220a or 220b shown in FIG. 2. The first MAC-ehs SDU 301 and the second MAC-ehs SDU 302 belong to different data streams. The first MAC-ehs SDU 301 and the second MAC-ehs SDU 302 are then mapped to the same first HARQ process: HARQ1 305. The first 301 and the second MAC-ehs SDU 302 are equal in size. The first MAC-ehs SDU 301 mapped to the first HARQ process 305 is then transformed into a first transport block TBS1 311 in layer 1. The second MAC-ehs SDU 302 mapped to the first HARQ process 305 is then transformed into a second transport block TBS2 312 in layer 1. A MAC-ehs SDU comprises a transmission sequence number TSN and data. Further in FIG. 3, a third MAC-ehs SDU 303 and a fourth MAC-ehs SDU 304 are input to the HARQ entity 320. The third MAC-ehs SDU 303 and the fourth MAC-ehs SDU 304 belong to different data streams. The third MAC-ehs SDU 303 and the fourth MAC-ehs SDU 304 are then mapped to the same second HARQ process: HARQ2 306. The third 303 and the fourth MAC-ehs SDU 304 are equal in size. The third MAC-ehs SDU 303 mapped to the second HARQ process 306 is then transformed into a third transport block TBS1 313 in layer 1. The fourth MAC-ehs SDU 304 mapped to the second HARQ process 306 is then transformed into a fourth transport block TBS4 314 in layer 1.

Three different combinations of streams to HARQ process mapping are possible. In the first combination, the first stream and second stream are mapped to the first HARQ process while the third stream and the fourth stream are mapped to the second HARQ process. In the second combination, the first stream and the third stream are mapped to the first HARQ process while the second stream and the fourth stream are mapped to the second HARQ process. In a third combination, the first stream and the fourth stream are mapped to the first HARQ process while the second stream and the third stream are mapped to the second HARQ process. The three different combinations are shown in Table 1.

TABLE 1
Streams to HARQ process mapping table in MAC-ehs UTRAN side

HARQ process

| | 1^{st} HARQ | 2^{nd} HARQ |
|---|---|---|
| 4Tx Streams | Stream 1, Stream 2 | Stream 3, Stream 4 |
| Combinations | Stream 1, Stream 3 | Stream 2, Stream 4 |
| | Stream 1, Stream 4 | Stream 2, Stream 3 |

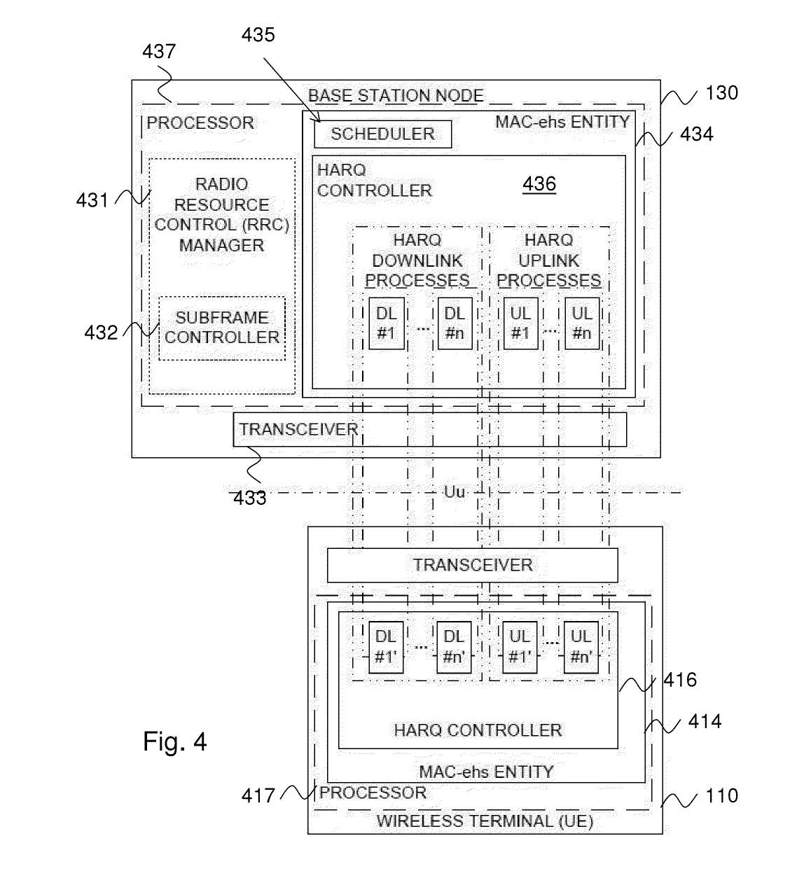

FIG. 4 shows portions of an example telecommunications system which may implement the technology disclosed herein. FIG. 4 particularly shows portions of a radio access network, RAN, including a base station node 130 and a wireless terminal, or UE 110. In the example system of FIG. 4, the base station node 130 and the wireless terminal 110 communicate over a radio or air interface known as the Uu interface (depicted by a dashed-dotted line), and particularly communicate using frames of information. Each frame usually comprises plural subframes. A subframe may comprise a signaling portion and a data portion, with the data portion often being used to include or transmit, among other things, one or more data transport blocks, or simply “transport blocks”, TBs. In general, once a HARQ process has acknowledged successful reception of a transport block, the next transport block is prepared by the sending node and is then subject to HARQ processing. The sending node may be either the base station node or the UE.

The radio access network of FIG. 4 may be e.g. either UTRAN or LTE. Accordingly, in some embodiments the base station node 130 of FIG. 4 may be a NodeB or an eNodeB, depending on the nature of the radio access network. Since in at least some example embodiments such as LTE embodiments, for example, the base station node 130 may include functionalities/elements such as a Radio Resource Control (RRC) Manager 431 which includes a subframe controller 432, such functionalities/elements are shown by dotted lines in FIG. 4.

The base station node 130 of FIG. 4 includes a transceiver 433 or radio interface unit which may facilitate transmission of plural streams of information across the Uu interface. In an example implementation, the transceiver facilitates transmission of four streams of information and comprises four antennae.

The base station node 130 of FIG. 4 further comprises one or more MAC-ehs entities 434. The MAC-ehs entity 434 comprises a scheduler 435 which performs, e.g. the HSDPA scheduler functions mentioned above. In addition, the MAC-ehs entity 434 comprises a HARQ controller 436. The HARQ controller 436 hosts, e.g., performs, executes, or constitutes, plural HARQ downlink, DL, processes, depicted in FIG. 4 as processes DL#1 through DL#n, as well as plural HARQ uplink, UL, processes, depicted as processes UL#1 through UL#n. A grouping of HARQ processes into DL processes and UL processes is depicted by dashed-doubled dotted lines in FIG. 4.

The functionalities of the base station node 130 of FIG. 4, including the RRC manager 431 and the MAC-ehs entity 434, as well as its scheduler 435 and HARQ controller 436 may comprise or otherwise be realized by, at least in part, a processor 437, as depicted by a dashed line in FIG. 4.

The wireless terminal 110 may be called by other names and comprise different types of equipment. For example, the wireless terminal may also be called a mobile station, wireless station, or user equipment unit (UE), and may be equipment such as a mobile telephone (“cellular” telephone) and a laptop with mobile termination, and thus may be, for example, portable, pocket, hand-held, computer-included, or car-mounted mobile devices which communicate voice and/or data with radio access network.

As also shown in FIG. 4, the wireless terminal 110 comprises a MAC-ehs entity 414, which in turn comprises a HARQ controller 416. The HARQ controller 416 of the wireless terminal hosts (e.g., performs, executes, or constitutes) plural HARQ DL processes, depicted in FIG. 4 as processes DL#1′ through DL#n′, as well as plural HARQ UL processes, depicted as processes UL#1′ through UL#n′. The functionalities of the wireless terminal 110 of FIG. 4, including the MAC-ehs entity 414, as well as its HARQ controller 416, may comprise or otherwise be realized by, at least in part, a processor 417, as depicted by a dashed line in FIG. 4.

In the nomenclature and notation of FIG. 4, a HARQ DL process is a process which provides an acknowledgement, whether positive or negative, for a transmission on the DL from the base station node 130 to the wireless terminal 110. Both HARQ process DL#1 and HARQ process DL#1′ cooperate to provide such an acknowledgement for one such DL transmission, with the acknowledgement being sent on the uplink from wireless terminal 110 to the base station node 130.

Each HARQ process may comprise one or more state variables, e.g., a memory for state variables. Each of state variable(s) may include a New Data Indicator, NDI. In addition, the state variable(s) may comprise other state variables such as the number of times a MAC PDU has been transmitted, current redundancy version, and HARQ feedback. Further, each HARQ process may comprise a buffer whose contents may also at least partially represent state information, and thus a buffer handler for handing the respective buffer. For example, for a DL HARQ downlink the wireless terminal 110 may comprises a buffer handler which operates upon one or more soft buffers and a soft combiner. For the HARQ DL process, the base station node 130 may comprise a buffer for storing a MAC PDU that is to be sent to the wireless terminal 110.

Based on status reports from associated uplink signaling, e.g. from the wireless terminal, an occasion for either new transmission or retransmission from the base station node is determined by the scheduler 435. For three streams or four streams transmissions, if a positive acknowledgement (ACK) is received, the scheduler may re-use the ACK transmission sequence numbers, TSNs, and force the wireless terminal 110 or UE to flush the two soft buffers that are logically mapped to the same HARQ process.

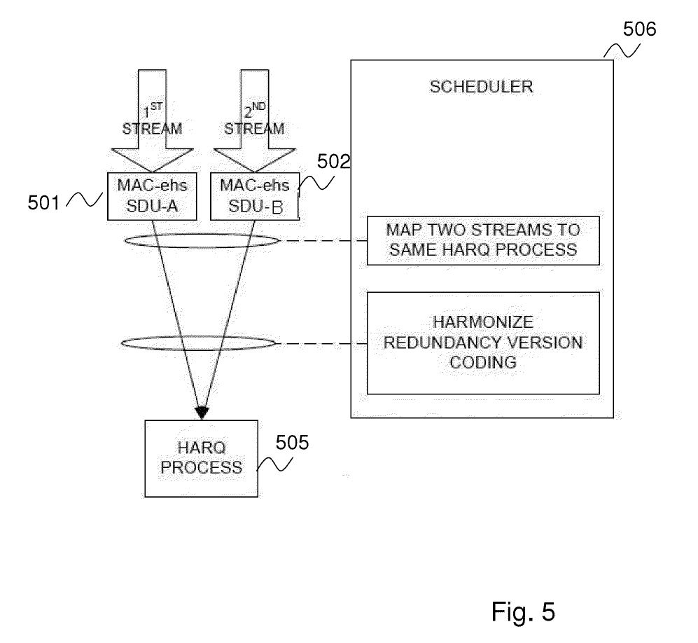

FIG. 5 shows various acts or steps which comprise the technology disclosed herein. MAC-ehs SDU-A 501 for the first stream and MAC-ehs SDU-B 502 for the second stream are mapped to the same HARQ process 505. Before transmitting from the base station node, the scheduler 506 determines the redundancy version coding for the MAC-ehs SDU-A 501, e.g., redundancy version 1, for example, and harmonizes the redundancy version coding for the MAC-ehs SDU-B 502, so that the redundancy version coding for MAC-ehs SDU-B 502 is the same as the redundancy version coding for Mac-ehs SDU-A 501, e.g. redundancy version 1 in the example above. In other words, for the initial transmission and following transmissions, the same redundancy versions coding determined by the scheduler should be used for the two MAC-ehs SDUs that are logically mapped to the same HARQ process.

When the retransmissions originating from the HARQ layer within the same TTI over the same HS-DSCH are scheduled, the redundancy versions coding determined by the scheduler 506 for the current retransmission and/or the following retransmissions should be the same for the two MAC-ehs SDUs 501, 502 that are logically mapped to the same HARQ process 505. That is, if any or both of the MAC-ehs SDU-A and MAC-ehs SDU-B are failed and need to be retransmitted, then before retransmitting, the scheduler 506 determines the redundancy version coding for MAC-ehs SDU-A 501, e.g., redundancy version 2. Accordingly, the redundancy version coding for MAC-ehs-SDU-B 502 should also be 2.

If MAC-ehs SDU-A 501 and MAC-ehs SDU-B 502 are mapped to the same HARQ process 505, then even if one SDU failed, e.g., MAC-ehs SDU-A failed but MAC-ehs SDU-B passed, the network would still need to retransmit both MAC-ehs SDU-A 501 and MAC-ehs SDU-B 502.

Thus, basic acts or steps may include:

When the number of streams is greater than 2, map the two equal-in-size MAC-ehs SDUs to one HARQ process in MAC-ehs UTRAN side, as shown in e.g. FIG. 3. The streams to HARQ process mapping combinations in MAC-ehs UTRAN side may be as shown in Table 1.

Keeping or harmonizing the same redundancy versions coding determined by the scheduler for in-transmissions and retransmissions for the two MAC-ehs SDUs that are logically mapped to the same HARQ process.

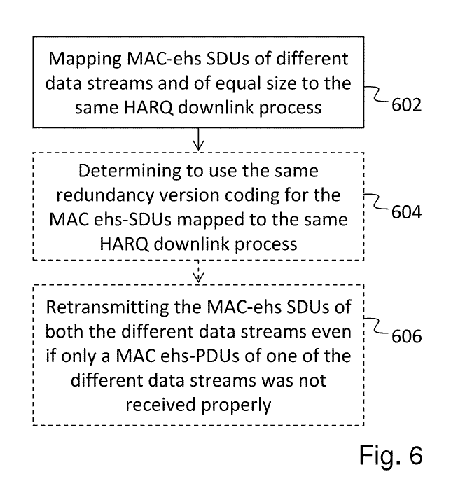

FIG. 6 illustrates a method according to a possible embodiment, performed by a base station for controlling transmission of data streams from the base station to a UE in a wireless communication system. The base station provides transmission of at least three data streams. The base station further provides only two different hybrid automatic retransmission request, HARQ, downlink processes. The method comprises mapping 602 Medium Access Control enhanced high speed, MAC-ehs, service data units, SDUs belonging to two different data streams of the at least three data streams to the same of the two different HARQ downlink processes. Further, the MAC-ehs SDUs belonging to two different data streams are of equal size. By mapping MAC-ehs SDUs belonging to two different data streams to the same HARQ process in such a way that MAC-ehs SDUs that are of equal size are mapped to the same HARQ process, it is possible to use only two HARQ processes for three or more data streams. In other words, two different data streams may use the same HARQ process. Thereby, a more cost-effective implementation is achieved compared to if one HARQ process per data stream is used. Also, transmission performance of the base station is kept on a similar level as if one HARQ process per data stream would have been used.

According to an embodiment, the at least three data streams comprises a first data stream, a second data stream, a third data stream and a fourth data stream. According to a first alternative, a MAC-ehs SDU belonging to the first data stream and a MAC-ehs SDU belonging to the second data stream are of equal size and are mapped 602 to a first of the two different HARQ processes. Further, a MAC-ehs SDU belonging to the third data stream and a MAC-ehs SDU belonging to the fourth data stream are of equal size and are mapped 602 to a second of the two different HARQ processes. According to a second alternative, a MAC-ehs SDU belonging to the first data stream and a MAC-ehs SDU belonging to the third data stream are of equal size and are mapped 602 to a first of the two different HARQ processes. Further, a MAC-ehs SDU belonging to the second data stream and a MAC-ehs SDU belonging to the fourth data stream are of equal size and are mapped 602 to a second of the two different HARQ processes. According to a third alternative, a MAC-ehs SDU belonging to the first data stream and a MAC-ehs SDU belonging to the fourth data stream are of equal size and are mapped 602 to a first of the two different HARQ processes. Further, a MAC-ehs SDU belonging to the second data stream and a MAC-ehs SDU belonging to the third data stream are of equal size and are mapped 602 to a second of the two different HARQ processes.

According to another alternative, the at least three data streams are only three data streams, i.e. a first data stream, a second data stream and a third data stream. A MAC-ehs SDU belonging to the second data stream and a MAC-ehs SDU belonging to the third data stream are of equal size and are mapped 602 to a first of the two different HARQ processes. The MAC-ehs SDU belonging to the first data stream are mapped to a second of the two different HARQ processes.

According to an embodiment, the method may further comprise the optional step of determining 604 a redundancy version coding for the MAC-ehs SDUs belonging to the two different data streams mapped to the same HARQ downlink process such that the same redundancy version coding is used for the MAC-ehs SDUs belonging to the two different data streams. By using the same redundancy version coding for MAC-ehs SDUs belonging to different data streams the same HARQ process may be used for retransmissions of the different data streams.

According to another embodiment, the method may further comprise the optional step of retransmitting 606 the MAC-ehs SDUs belonging to the two different data streams mapped to the same HARQ downlink process even if only a MAC-ehs SDU of one of the two different data streams was not received properly by the UE.

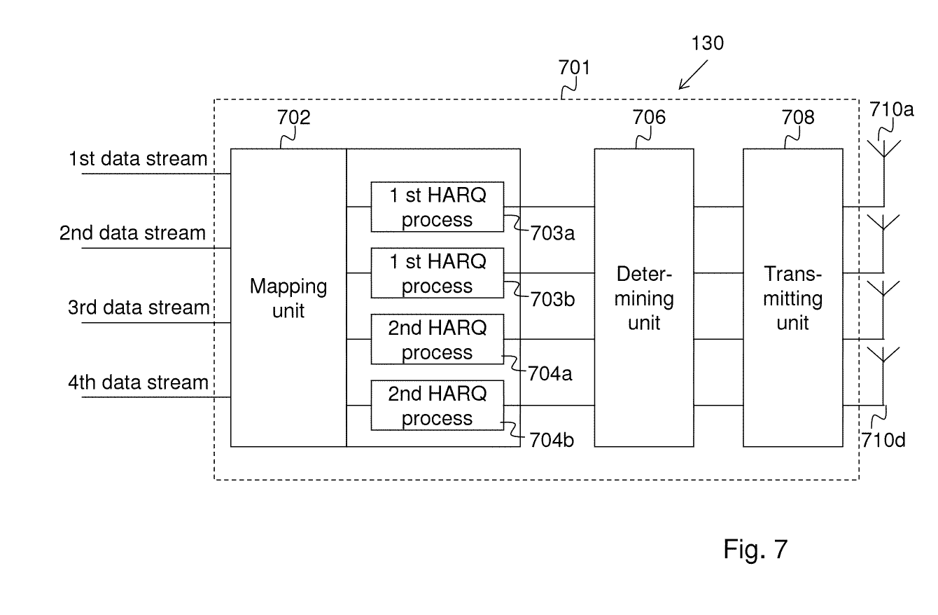

FIG. 7 illustrates a base station 130 according to an embodiment, configured to control transmission of data streams from the base station to a UE in a wireless communication system. The base station provides transmission of at least three data streams. The base station further provides only two different hybrid automatic retransmission request, HARQ, downlink processes 703ab, 704ab. The base station comprises a mapping unit 702 for mapping Medium Access Control enhanced high speed, MAC-ehs, service data units, SDUs belonging to two different data streams of the at least three data streams to the same of the two different HARQ downlink processes. The MAC-ehs SDUs belonging to two different data streams are of equal size.

According to an embodiment, the at least three data streams comprises a first data stream, a second data stream, a third data stream and a fourth data stream. According to a first alternative, a MAC-ehs SDU belonging to the first data stream and a MAC-ehs SDU belonging to the second data stream are of equal size and the mapping unit 702 is configured to map the MAC-ehs SDU belonging to the first data stream and the MAC-ehs SDU belonging to the second data stream to a first of the two different HARQ processes. Further, a MAC-ehs SDU belonging to the third data stream and a MAC-ehs SDU belonging to the fourth data stream are of equal size and the mapping unit 702 is configured to map the MAC-ehs SDU belonging to the third data stream and the MAC-ehs SDU belonging to the fourth data stream to a second of the two different HARQ processes. According to a second alternative, a MAC-ehs SDU belonging to the first data stream and a MAC-ehs SDU belonging to the third data stream are of equal size and the mapping unit 702 is configured to map the MAC-ehs SDU belonging to the first data stream and the MAC-ehs SDU belonging to the third data stream to a first of the two different HARQ processes. Further, a MAC-ehs SDU belonging to the second data stream and a MAC-ehs SDU belonging to the fourth data stream are of equal size and the mapping unit 702 is configured to map the MAC-ehs SDU belonging to the second data stream and the MAC-ehs SDU belonging to the fourth data stream to a second of the two different HARQ processes. According to a third alternative, a MAC-ehs SDU belonging to the first data stream and a MAC-ehs SDU belonging to the fourth data stream are of equal size and the mapping unit 702 is configured to map the MAC-ehs SDU belonging to the first data stream and the MAC-ehs SDU belonging to the fourth data stream to a first of the two different HARQ processes. Further, a MAC-ehs SDU belonging to the second data stream and a MAC-ehs SDU belonging to the third data stream are of equal size and the mapping unit 702 is configured to map the MAC-ehs SDU belonging to the second data stream and the MAC-ehs SDU belonging to the third data stream to a second of the two different HARQ processes.

According to an embodiment, the base station 130 further comprises a determining unit 706 configured to determine a redundancy version coding for the MAC-ehs SDUs belonging to the two different data streams mapped to the same HARQ downlink process such that the same redundancy version coding is used for the MAC-ehs SDUs belonging to the two different data streams.

According to another embodiment, the base station 130 further comprises a transmitting unit 708 configured to re-transmit the MAC-ehs SDUs belonging to the two different data streams mapped to the same HARQ downlink process even if only a MAC-ehs SDU of one of the two different data streams was not received properly by the UE.

In the embodiment of a base station shown in FIG. 7, four different data streams are fed into the mapping unit 702. The mapping unit 702 is configured to map the data streams to a first HARQ process 703ab and a second HARQ process 704ab such that two data streams having MAC-ehs SDUs of equal size are mapped to the same HARQ process. In FIG. 7 each of the first and the second HARQ process is shown with two separate boxes to illustrate the feeding of each of the data streams through the base station. After being fed through the mapping unit 702, the data streams are fed to the determining unit 706 and further to the transmitting unit 708. Thereafter, the data streams are each fed to an antenna 710a-d for further transmission over an air interface to UEs.

The mapping unit 702, the determining unit 706 and the transmitting unit 708 may be arranged in an arrangement 701. The arrangement 701 could be implemented e.g. by one or more of: a processor or a micro processor and adequate software and storage therefore, a Programmable Logic Device (PLD) or other electronic component(s)/processing circuit(s) configured to perform the actions, or methods, mentioned above.

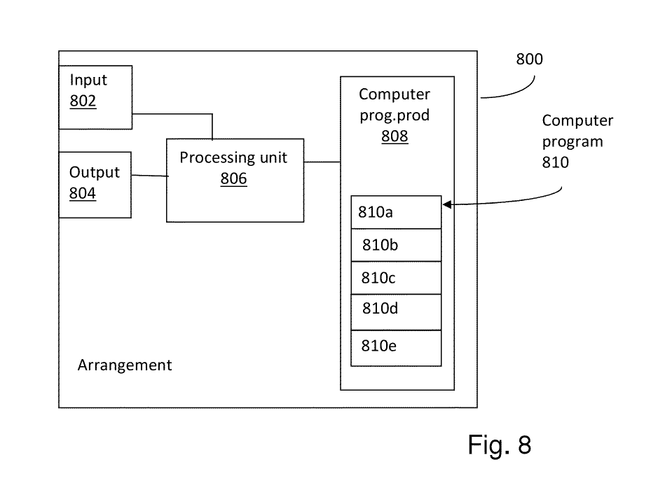

FIG. 8 schematically shows an embodiment of an arrangement 800 for use in a base station 130, which also can be an alternative way of disclosing an embodiment of the arrangement 701 in a base station 130 illustrated in FIG. 7. Comprised in the arrangement 800 is a processing unit 806, e.g. with a Digital Signal Processor (DSP). The processing unit 806 may be a single unit or a plurality of units to perform different actions of procedures described herein. The arrangement 800 may also comprise an input unit 802 for receiving signals from other entities, and an output unit 804 for providing signal(s) to other entities. The input unit 802 and the output unit 804 may be arranged as an integrated entity.

Furthermore, the arrangement 800 comprises at least one computer program product 808 in the form of a non-volatile or volatile memory, e.g. an Electrically Erasable Programmable Read-only Memory (EEPROM), a flash memory, a disk drive or a Random-access memory (RAM). The computer program product 808 comprises a computer program 810, which comprises code means, which when executed in the processing unit 806 in the arrangement 800 causes the arrangement 701 and/or the base station 130 to perform the actions of any of the procedures described earlier in conjunction with FIG. 6.

The computer program 810 may be configured as a computer program code structured in computer program modules. Hence, in an exemplifying embodiment, the code means in the computer program 810 of the arrangement 800 comprises a mapping module 810a for mapping MAC-ehs SDUs belonging to two different data streams of at least three data streams to the same of two different HARQ downlink processes. The MAC-ehs SDUs belonging to two different data streams are of equal size. The computer program may further comprise determining module 810b for determining a redundancy version coding for the MAC-ehs SDUs belonging to the two different data streams mapped to the same HARQ downlink process such that the same redundancy version coding is used for the MAC-ehs SDUs belonging to the two different data streams. The computer program may further comprise a transmission module 810c for retransmitting the MAC-ehs SDUs belonging to the two different data streams mapped to the same HARQ downlink process even if only a MAC-ehs SDU of one of the two different data streams was not received properly by the UE.

The acts which have above been described as being implemented or executed by a processor may be performed by any suitable machine. The machine may take the form of electronic circuitry in the form of a computer implementation platform or a hardware circuit platform. A computer implementation of the machine platform may be realized by or implemented as one or more computer processors or controllers as those terms are herein expansively defined, and which may execute instructions stored on non-transient computer-readable storage media. In such a computer implementation the machine platform may comprise, in addition to a processor(s), a memory section, which in turn can comprise random access memory; read only memory; an application memory, a non-transitory computer readable medium which stores, e.g., coded non instructions which can be executed by the processor to perform acts described herein; and any other memory such as cache memory, for example. Another example platform suitable is that of a hardware circuit, e.g., an application specific integrated circuit, ASIC, wherein circuit elements are structured and operated to perform the various acts described herein.

Although the description above contains much specificity, these should not be construed as limiting the scope of the invention but as merely providing illustrations of some of the presently preferred embodiments of this invention. It will be appreciated that the scope of the present invention fully encompasses other embodiments which may become obvious to those skilled in the art, and that the scope of the present invention is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the present invention, for it to be encompassed hereby.

1. Method performed by a base station for controlling transmission of data streams from the base station to a user equipment, UE, in a wireless communication system, the base station providing transmission of at least three data streams, the base station further providing only two different hybrid automatic retransmission request, HARQ, downlink processes, the method comprising:
Mapping Medium Access Control enhanced high speed, MAC-ehs, service data units, SDUs belonging to two different data streams of the at least three data streams to the same of the two different HARQ downlink processes, wherein the MAC-ehs SDUs belonging to two different data streams are of equal size.

2. Method according to claim 1, wherein the at least three data streams comprises a first data stream, a second data stream, a third data stream and a fourth data stream, and wherein a MAC-ehs SDU belonging to the first data stream and a MAC-ehs SDU belonging to the second data stream are of equal size and are mapped to a first of the two different HARQ processes, and wherein a MAC-ehs SDU belonging to the third data stream and a MAC-ehs SDU belonging to the fourth data stream are of equal size and are mapped to a second of the two different HARQ processes.

3. Method according to claim 1, wherein the at least three data streams comprises a first data stream, a second data stream, a third data stream and a fourth data stream, and wherein a MAC-ehs SDU belonging to the first data stream and a MAC-ehs SDU belonging to the third data stream are of equal size and are mapped to a first of the two different HARQ processes, and wherein a MAC-ehs SDU belonging to the second data stream and a MAC-ehs SDU belonging to the fourth data stream are of equal size and are mapped to a second of the two different HARQ processes.

4. Method according to claim 1, wherein the at least three data streams comprises a first data stream, a second data stream, a third data stream and a fourth data stream, and wherein a MAC-ehs SDU belonging to the first data stream and a MAC-ehs SDU belonging to the fourth data stream are of equal size and are mapped to a first of the two different HARQ processes, and wherein a MAC-ehs SDU belonging to the second data stream and a MAC-ehs SDU belonging to the third data stream are of equal size and are mapped to a second of the two different HARQ processes.

5. Method according to claim 1, further comprising:
determining a redundancy version coding for the MAC-ehs SDUs belonging to the two different data streams mapped to the same HARQ downlink process such that the same redundancy version coding is used for the MAC-ehs SDUs belonging to the two different data streams.

6. Method according to claim 1, further comprising:
retransmitting the MAC-ehs SDUs belonging to the two different data streams mapped to the same HARQ downlink process even if only a MAC-ehs SDU of one of the two different data streams was not received properly by the UE.

7. Base station configured to control transmission of data streams from the base station to a user equipment, UE, in a wireless communication system, the base station providing transmission of at least three data streams, the base station further providing only two different hybrid automatic retransmission request, HARQ, downlink processes, the base station comprising:
A mapping unit for mapping Medium Access Control enhanced high speed, MAC-ehs, service data units, SDUs belonging to two different data streams of the at least three data streams to the same of the two different HARQ downlink processes, wherein the MAC-ehs SDUs belonging to two different data streams are of equal size.

8. Base station according to claim 7, wherein the at least three data streams comprises a first data stream, a second data stream, a third data stream and a fourth data stream, and wherein a MAC-ehs SDU belonging to the first data stream and a MAC-ehs SDU belonging to the second data stream are of equal size and the mapping unit is configured to map the MAC-ehs SDU belonging to the first data stream and the MAC-ehs SDU belonging to the second data stream to a first of the two different HARQ processes, and wherein a MAC-ehs SDU belonging to the third data stream and a MAC-ehs SDU belonging to the fourth data stream are of equal size and the mapping unit is configured to map the MAC-ehs SDU belonging to the third data stream and the MAC-ehs SDU belonging to the fourth data stream to a second of the two different HARQ processes.

9. Base station according to claim 7, wherein the at least three data streams comprises a first data stream, a second data stream, a third data stream and a fourth data stream, and wherein a MAC-ehs SDU belonging to the first data stream and a MAC-ehs SDU belonging to the third data stream are of equal size and the mapping unit is configured to map the MAC-ehs SDU belonging to the first data stream and the MAC-ehs SDU belonging to the third data stream to a first of the two different HARQ processes, and wherein a MAC-ehs SDU belonging to the second data stream and a MAC-ehs SDU belonging to the fourth data stream are of equal size and the mapping unit is configured to map the MAC-ehs SDU belonging to the second data stream and the MAC-ehs SDU belonging to the fourth data stream to a second of the two different HARQ processes.

10. Base station according to claim 7, wherein the at least three data streams comprises a first data stream, a second data stream, a third data stream and a fourth data stream, and wherein a MAC-ehs SDU belonging to the first data stream and a MAC-ehs SDU belonging to the fourth data stream are of equal size and the mapping unit is configured to map the MAC-ehs SDU belonging to the first data stream and the MAC-ehs SDU belonging to the fourth data stream to a first of the two different HARQ processes, and wherein a MAC-ehs SDU belonging to the second data stream and a MAC-ehs SDU belonging to the third data stream are of equal size and the mapping unit is configured to map the MAC-ehs SDU belonging to the second data stream and the MAC-ehs SDU belonging to the third data stream to a second of the two different HARQ processes.

11. Base station according to claim 7, further comprising a determining unit configured to determine a redundancy version coding for the MAC-ehs SDUs belonging to the two different data streams mapped to the same HARQ downlink process such that the same redundancy version coding is used for the MAC-ehs SDUs belonging to the two different data streams.

12. Base station according to claim 7, further comprising a transmitting unit configured to re-transmit the MAC-ehs SDUs belonging to the two different data streams mapped to the same HARQ downlink process even if only a MAC-ehs SDU of one of the two different data streams was not received properly by the UE.

13. A computer program comprising computer readable code means, which when run in a base station configured to control transmission of data streams from the base station to a user equipment, UE, wherein the base station provides transmission of at least three data streams and the base station further provides only two different hybrid automatic retransmission request, HARQ, downlink processes, causes the base station to perform the following step:
mapping Medium Access Control enhanced high speed, MAC-ehs, service data units, SDUs belonging to two different data streams of the at least three data streams to the same of the two different HARQ downlink processes, wherein the MAC-ehs SDUs belonging to two different data streams are of equal size.

14. A computer program product, comprising a computer readable medium and a computer program according to claim 13 stored on the computer readable medium.
